(19) United States
(12) Patent Application Publication
(10) Pub. No.: US 2022/0171773 A1
(43) Pub. Date: Jun. 2, 2022

(54) OPTIMIZING EXPANSION OF USER QUERY INPUT IN NATURAL LANGUAGE PROCESSING APPLICATIONS

(71) Applicant: International Business Machines Corporation, Armonk, NY (US)

(72) Inventors: Seamus R. Mac an tSaoir, Navan (IE); Ahmed M. M. R. Salem, Dublin (IE)

(21) Appl. No.: 17/108,621

(22) Filed: Dec. 1, 2020

(51) Int. Cl. G06F 16/2453; G06F 16/242; G06F 40/284; G06F 40/30

(52) U.S. Cl. CPC G06F 16/2453; G06F 40/30; G06F 40/284; G06F 16/243

(57) ABSTRACT

A processor may identify a lexical answer type for a user query input. The user query input may be in the form of a natural language input. The processor may feel the lexical answer type into a query expansion method to expand the user query input with one or more precise terms based on the lexical answer type. The processor may output one or more lexical answer type query expansions for use as inputs into a natural language processing application.

### BACKGROUND

The present disclosure relates to natural language processing and, more specifically, to optimizing expansion of user query input in natural language processing applications.

Query expansion is a critical process in any information retrieval system. It enhances the chances of retrieving the best result for a user's query. Very often, the original query is not sufficient to retrieve the target content, whether through ambiguity (latent or otherwise), a terminology gap, or general lack of overlap between query and content.

However, query expansion can also be error prone and can as easily reduce the accuracy of retrieved documents as improve it. One way to improve the likelihood of improving rather than reducing accuracy is to target a specific aspect of the user's query that is most likely to yield relevant expansions.

The lexical answer type (LAT) is the piece of the input that describes the type of content required to satisfy the user's query. In the legal domain, it could be a historical judgement or chapter in the law. In the medical domain, it could be a treatment for a specific disease. In the finance domain, it could be focused on a specific type of financial product or loan.

The LAT is conventionally used in the context of question-answering, especially simple fact use-cases, where the user's input is in the form of a natural language question, such as, “What is the capital of India?” The LAT in this example is “capital,” and this lexical form describes the category or type that should be exhibited by any answer satisfying this request. Potential answers can be evaluated as to how closely they exhibit this identified category, e.g., is the answer a capital? In question-answering, the LAT is used to filter out undesirable answers, or as a means to differentiate (or score more highly) answers that exhibit desirable qualities.

### SUMMARY

According to an aspect of the present disclosure, a method, system, and computer program product for optimizing expansion of user query input in natural language processing applications is provided. In some embodiments of the present disclosure, a method may include identifying a lexical answer type for a user query input wherein the user query input is in the form of a natural language input. Furthermore, a method may include feeding the identified lexical answer type into a query expansion method to expand the user query input with one or more precise terms based on the lexical answer type. Moreover, a method may include outputting one or more lexical answer type query expansions for use as inputs into a natural language processing application.

According to another aspect of the present disclosure, a system may include a processor and a memory configured to provide computer program instructions to the processor to execute a function of the components. The components may include a lexical answer type extraction component for identifying a lexical answer type for a user query input wherein the user query input is in the form of a natural language input. The components may further include a query expansion component for receiving as input the identified lexical answer type to expand the query with one or more precise terms based on the lexical answer type. The components may also include a query expansion output component for outputting one or more lexical answer type query expansions for use as inputs into a natural language processing application.

According to a further aspect of the present disclosure, the computer program product may include a computer readable storage medium having program instructions embodied therewith. The program instructions may be executable by a processor to cause the processor to identify a lexical answer type for a user query input wherein the user query input is in the form of a natural language input. The program instructions may also cause the processor to feed the identified lexical answer type into a query expansion method to expand the user query input with one or more precise terms based on the lexical answer type. The program instructions may further cause the processor to output one or more lexical answer type query expansions for use as inputs into a natural language processing application. The computer readable storage medium may be a non-transitory computer readable storage medium and the computer readable program code may be executable by a processing circuit.

### BRIEF DESCRIPTION OF THE DRAWINGS

The subject matter regarded as the present disclosure is particularly pointed out and distinctly claimed in the concluding portion of the specification. The disclosure, both as to organization and method of operation, together with objects, features, and advantages thereof, may best be understood by reference to the following detailed description when read with the accompanying drawings.

Preferred embodiments of the present disclosure will now be described, by way of example only, with reference to the following drawings.

FIG. 1 is a flow diagram of an example embodiment of a method in accordance with the present disclosure.

FIG. 2 is a schematic flow diagram of an example embodiment of a query expansion in accordance with the present disclosure.

FIG. 3 is block diagram of an example embodiment of a system in accordance with the present disclosure.

FIG. 4 is a block diagram of an embodiment of a computer system or cloud server in which the present disclosure may be implemented.

FIG. 5 is a schematic diagram of a cloud computing environment in which the present disclosure may be implemented.

FIG. 6 is a diagram of abstraction model layers of a cloud computing environment in which the present disclosure may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

A method, system, and computer program product are provided for optimizing expansion of a user's query input with one or more precise terms by using a lexical answer type (LAT) in a query expansion process to improve the likelihood that the query returns results containing the actual data required by the user. The LAT is a portion of the input that describes or infers aspects of the particular content required to satisfy the user's query.

By ensuring that expansion of the user's query targets the LAT, the expansion of the query is more likely to generate relevant results than to produce irrelevant noise. Nonetheless, depending on the expansion technique, if the context of the rest of the query content is not taken into account, the results can be almost as noisy as before.

By leveraging the LAT in the described method, system, and computer program product, a user's query input can be expanded with more precise terms to ensure that the query more likely returns results containing the actual data required by the user. There are many cases across multiple domains where the identification of descriptive aspects of the potential answer, as identified by the user in the query input, can be of great benefit in searching for suitable documents. This has relevance to any scenario where the user expresses their query in the form of a natural language phrase or question.

Instead of using the LAT to filter answers obtained for an input query, the LAT is used to expand the question or phrase being used as the query input to provide clarification and therefore more accurate results. The user query input may be in the form of a question or another form of phrase or statement that is structured to obtain an answer, for example, “This author wrote Jane Eyre.”

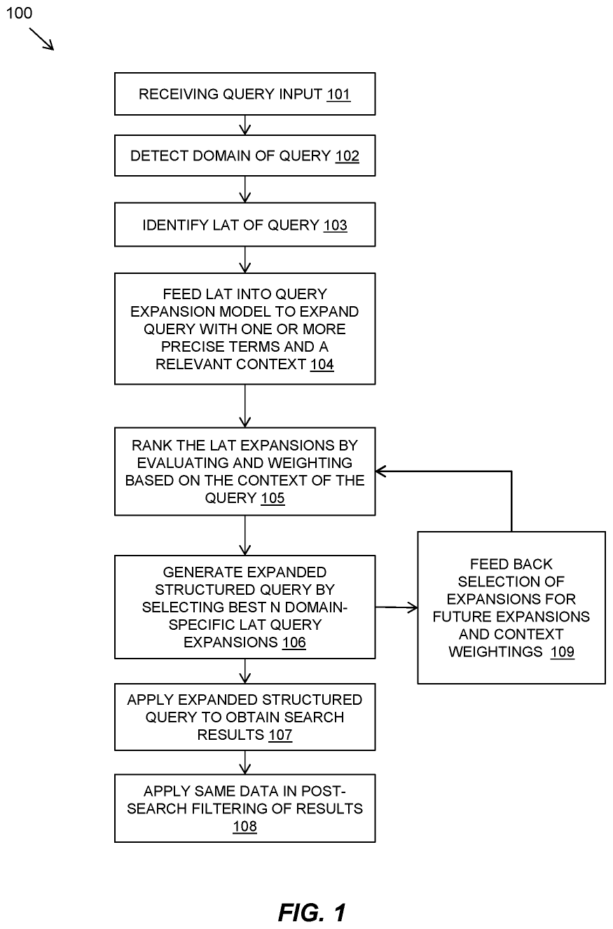

Referring to FIG. 1, a flow diagram 100 shows an example embodiment of the described method carried out for a natural language processing application. The natural language applications may be used in any scenario where users ask questions that define the expected content, such as information retrieval, chatbot conversation systems, and other scenarios in which a natural language query in the form of a phrase or question is input and requires interpretation.

The method may receive a query input 101 in the form of a text input, for example, in the form of a natural language question.

The method identifies a LAT of the query input 103. The method may detect the domain of the query input 102 and, using a domain appropriate LAT extraction method, may identify the LAT of the query input 103. Alternatively, the LAT may be identified by using a general LAT detection method without specifying a domain of the query.

Detecting the domain of the query 102 may be carried out with many different techniques such as keyword density or a general vocabulary classifier. This task may be carried out by a separate component that has been trained with examples of every domain it should recognize. A traditional question/answer LAT detection may be used for targeted expansion of domain specific queries.

Alternatively, a general LAT detection component may be used in the event that a specific domain could not be detected. A general LAT detection component may detect the LAT as long as the grammatical structure and vocabulary is not overly domain specific.

A LAT is defined as a word or term in the question or phrase that indicates the type of the answer independent of assigning semantics to that word or term. A LAT may be extracted by a question analysis of a query input.

A query input in natural language includes a LAT and a focus which are separate parts of the question. The LAT is the piece describing the type of the answer, such as “capital,” “law,” or “medication.” The focus is the piece, along with the LAT, where the answer should be slotted in, for example, replacing who, what, which, et cetera. For example, in the medical domain, a sample question might be, “What medications can be used to treat breast cancer?” The LAT in this case would be “medications,” the focus would be “what medications.” An example correct answer might be “tamoxifen,” and a resulting answer could look like, “Tamoxifen can be used to treat breast cancer.”

Conventional methods for extracting the LAT and the focus of a question may be used, and two example implementations are as follows.

In one implementation, a rule-based method may be used which uses the logical grammatical structure of a sentence. A question phrase followed by a noun phrase indicates that the noun phrase may contain a LAT; thus, the noun phrase together with the question phrase may compose the focus of the question.

In another implementation, a machine learning method may be used where each word in the question is classified as to its likelihood of being a LAT given the surrounding words in the question text.

The method may feed the identified LAT into a query expansion method to expand the query input with one or more precise terms and relevant context 104. The LAT may be highlighted for expansion to focus query modifications on the target content.

Once a LAT is detected, this value can be fed, either in conjunction with surrounding context from the question or as a single term, to a range of algorithms designed for query expansion. The query expansion methods in some cases may only differ in that the output is restricted to only those expansions related to the LAT term. This can have consequences for the number of expansions produced per input term, which can now be increased given the restriction of output contexts.

Knowing that the input is a LAT can also strongly affect the type of expansion method used. The LAT has an inherent categorical nature which makes techniques like synonym lookup very effective (e.g., using a lexical database of synsets) whereas other more specific terms may not have readily available resources and, as such, would require more complicated and error prone expansion methods.

Known query expansion methods may be used to reformulate a query input to improve understanding of the query for retrieval performance or response. A query expansion method may be dictionary-based or ontology-based and may use knowledge bases and other word networks including the following: structured general knowledge graphs, including lexical databases, structured content extraction databases, open source knowledge bases, semantic web content databases, commonsense reasoning engine databases, encyclopedic dictionaries, et cetera; structured domain knowledge graphs, including the Financial Industry Business Ontology (FIBO), Unified Medical Language System (UMLS), et cetera; automatically extracted domain knowledge graphs, including prismatic frames; frequency weighted co-occurrence networks; and word vector normalization techniques, including latent semantic analysis.

The method may rank the obtained LAT query expansion by evaluating and weighting the query expansions based on contexts of the query input 105. LAT-based expansions may be weighted for contextual relevance using context-sensitive weighting, such as with knowledge graph activation.

A context is essentially an interpretation, and there may be several possible interpretations of the input question. Expanding the LAT term to additional related terms by itself would not facilitate weighting because there is nothing to tell the contexts apart. Through the use of terms in the input, each of the expansions can be weighted with relevance to the overall context, or most relevant contexts, as determined by an additional technique to establish context relevance of each interpretation.

The ranking may use all semantic concepts in the query input, including the LAT and the knowledge graphs, such as those listed above. The concepts associated with the LAT itself may be highly amplified as input into this process. Noise is minimal over generic use of the same query expansion techniques.

The expansions in the final activated sub-graph are sorted by relevance to the input using techniques such as degree of separation from LAT-concepts, degree of separation from focus (most highly activated concept), overall activation weight, and so on.

The method may generate an expanded structured query by selecting a number of the ranked LAT query expansions 106. The method may automatically select a top number n of the expansions or the method may present ranked expansions to a user for selection.

User feedback of selections may be fed back to enhance future expansions and context weightings 109 in structured knowledge graphs.

The method may output the expanded structure query for use in resolving the query. This may be used to obtain search results 107 for the query and such search results may be filtered 108 using the identified LAT and associated data for post-search filtering of results 108 to ensure correct content is present in all result documents. The output may be used in other natural language processing applications as the input to improve the relevance and quality of the response to the user query input.

A query expansion technique is therefore provided that leverages any available structured knowledge resources in a way that constrains the expansions to semantically relevant but well-known generic content classification terms. The described method targets a specific aspect of the query that is known to be generic and ambiguous, and thereby significantly increases the relevance of expansions.

The method is focused on the quality of search results or other results as determined by the restriction of query expansions to those related to the LAT. Leveraging the LAT and its expansions are used to optimize the results for the original query.

Typically, extraction of a LAT is for usage in a question answering system and does not involve query composition for search. Rather, the LAT is used to score relevance of answers extracted from search results after search has already completed.

A simplified example is given below with a query input of, “Who wrote the book Jane Eyre?” The domain can be detected as being “English literature.” The LAT in this sentence is “who,” for which there are infinite possible interpretations, such as person names, organizations, professions, et cetera. “Author” is used as a valid expansion of “who” due to the surrounding context of “wrote,” “book,” and “Jane Eyre,” each of which adds weight to the “author” interpretation. As a result, if “author” were suggested as an expansion, it would be weighted much more highly than, for example, “president.” Therefore, LAT query expansions may be obtained of, “What author wrote the book Jane Eyre?” and, “Who is the author of the book Jane Eyre?” The best LAT query expansions may be selected and applied to a search for the answer.

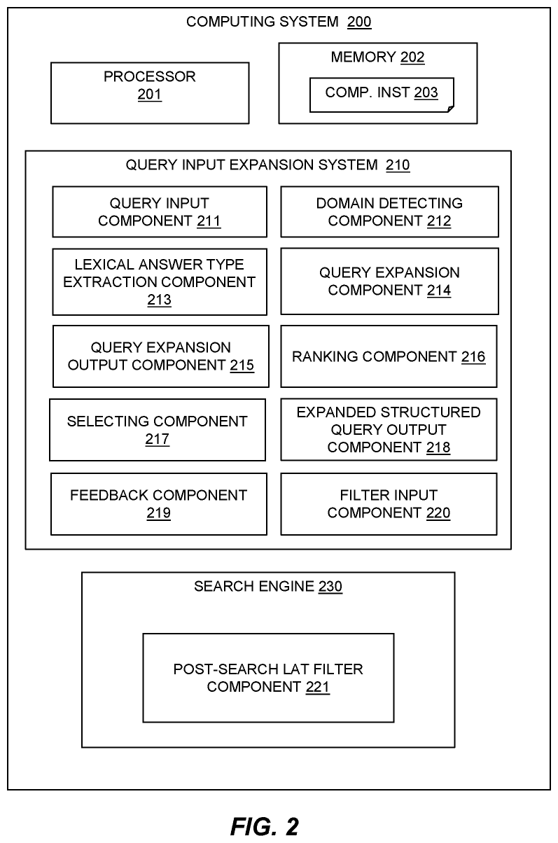

Referring to FIG. 2, a block diagram shows a computing system 200 at which the described query input expansion system 210 may be provided. The computing system 200 may include at least one processor 201, a hardware module, and/or a circuit for executing the functions of the described components which may be software units executing on the at least one processor 201. Multiple processors running parallel processing threads may be provided enabling parallel processing of some or all of the functions of the components. Memory 202 may be configured to provide computer instructions 203 to the at least one processor 201 to carry out the functionality of the components. Some of the components may be interface components for accessing services provided via a remote computing system. Some of the components may also access resources in the form of databases and ontologies or knowledge bases for use by the components.

The query input expansion system 210 may include a query input component 211 for receiving a query input and a domain detecting component 212 for detecting a domain of a query input. The query input expansion system 210 may include a LAT extraction component 213 for identifying a LAT for a query input. This may be based on a domain appropriate LAT extraction for a detected domain of the query or a general LAT extraction. The LAT extraction component 213 may access and outsource the task to a remote LAT extraction component.

The query input expansion system 210 may include a query expansion component 214 for receiving as input the identified LAT to expand the query with one or more precise terms and a query expansion output component 215 may output the query expansions. The query expansion component 214 may access and outsource the query expansion task to a remote query expansion component. A ranking component 216 may be provided for ranking the one or more LAT query expansions by evaluating and weighting the lexical answer type query expansions based on a context of the query input and a selecting component 217 may be provided for selecting a number of the ranked lexical answer type query expansions. The selecting component 217 may automatically select a top number n of the expansions. Alternatively, the selecting component 217 may receive a user selection of a number n of the expansions. When a user selection is made, a feedback component 219 may feed the user selection of expansions back to the ranking component 216 to enhance future expansions and context weightings.

The selected expansions may be used to generate an expanded structured query for output by an expanded structured query output component 218. This output may be used in a natural language processing (NLP) application to obtain results.

In some embodiments, the expanded structured query output may be input to a search engine 230 that may be provided at a same computing system 200 or remotely to the query input expansion system 210. The search engine 230 may include a post-search LAT filter component 221 for filtering search results based on the LAT as received from a filter input component 220 of the query input expansion system 210.

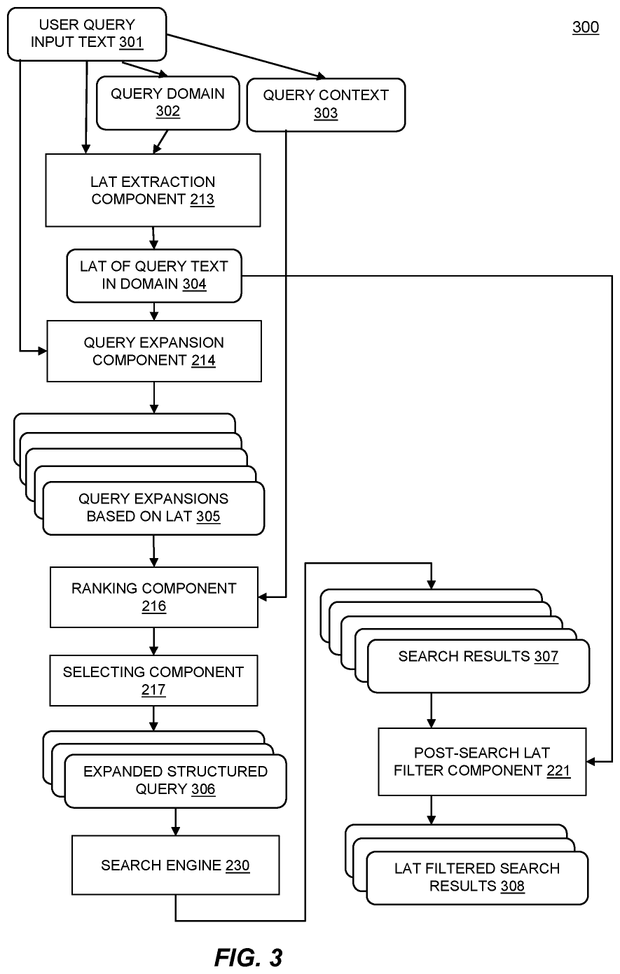

Referring to FIG. 3, a schematic diagram shows an example embodiment of a flow of data elements 300 through components of the query input expansion system 210 of FIG. 2.

A user query input text 301 may be received and a query domain 302 and query contexts 303 detected. The user query input text 301 and the query domain 302 are input into a LAT extraction component 213 to obtain a LAT of the query text in the domain 304. The LAT of the query text 304 and the query input text 301 are input into a query expansion component 214 to obtain query expansions 305 based on the LAT.

The query expansions 305 as well as the query contexts 303 are input into a ranking component 216 to rank query expansions. A selecting component 217 obtains selected query expansions that are used to generate an expanded structure query 306. The expanded structured query 306 may be used to resolve the query.

In some embodiments, this may be input into a search engine 230 to obtain search results 307. The search results 307 may be filtered by a post-search LAT filter component 221 that uses the LAT of the query text 304 and outputs LAT filtered search results 308. In some embodiments, this may be input into a natural language processing (NLP) conversation system such as a chatbot.

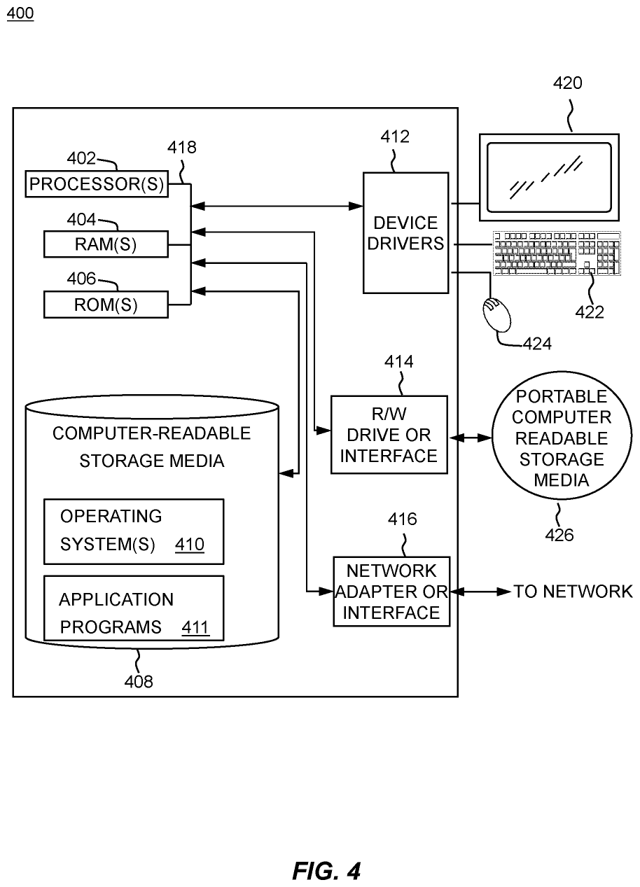

FIG. 4 depicts a block diagram of components of a computing system 400 as used for the server providing the query input expansion system in accordance with embodiments of the present disclosure. It should be appreciated that FIG. 4 provides only an illustration of an implementation and does not imply any limitations with regard to the environments in which different embodiments may be implemented. Many modifications to the depicted environment may be made in accordance with the present disclosure.

The computing system can include one or more processors 402, one or more computer-readable RAMs 404, one or more computer-readable ROMs 406, one or more computer readable storage media 408, one or more device drivers 412, one or more read/write drives or interfaces 414, and one or more network adapters or interfaces 416 all interconnected over a communications fabric 418. Communications fabric 418 can be implemented with any architecture designed for passing data and/or control information between processors (such as microprocessors, communications and network processors, et cetera), system memory, peripheral devices, and/or any other hardware components within the system.

One or more operating systems 410 and application programs 411, such as the query input expansion system 310, are stored on one or more of the computer readable storage media 408 for execution by one or more of the processors 402 via one or more of the respective RAMs 404 (which may include cache memory). In the illustrated embodiment, the computer readable storage media 408 may be a magnetic disk storage device of an internal hard drive, CD-ROM, DVD, memory stick, magnetic tape, magnetic disk, or optical disk, a semiconductor storage device such as RAM, ROM, EPROM, or flash memory, any other computer readable storage media that can store a computer program and digital information, or any combination thereof in accordance with embodiments of the disclosure.

The computing system can also include a R/W drive or interface 414 to read from and/or write to one or more portable computer readable storage media 426. Application programs 411 on the computing system can be stored on one or more of the portable computer readable storage media 426, read via the respective R/W drive or interface 414 and loaded into the respective computer readable storage media 408.

The computing system can also include a network adapter or interface 416, such as a TCP/IP adapter card or wireless communication adapter. Application programs 411 on the computing system can be downloaded to the computing device from an external computer or external storage device via a network (for example, the Internet, a local area network or other wide area networks or wireless networks) and network adapter or interface 416. From the network adapter or interface 416, the programs may be loaded into the computer readable storage media 408. The network may comprise copper wires, optical fibers, wireless transmission, routers, firewalls, switches, gateway computers, edge servers, or some combination thereof.

The computing system may also include a display screen 420, a keyboard and/or keypad 422, and/or a computer mouse and/or touchpad 424. Device drivers 412 may interface to a display screen 420, to keyboard or keypad 422, to computer mouse or touchpad 424, and/or to display screen 420 for pressure sensing of alphanumeric character entry and user selections. The device drivers 412, R/W drive or interface 414, and/or network adapter or interface 416 may comprise hardware and software stored in computer readable storage media 408 and/or ROM 406.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Cloud Computing

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

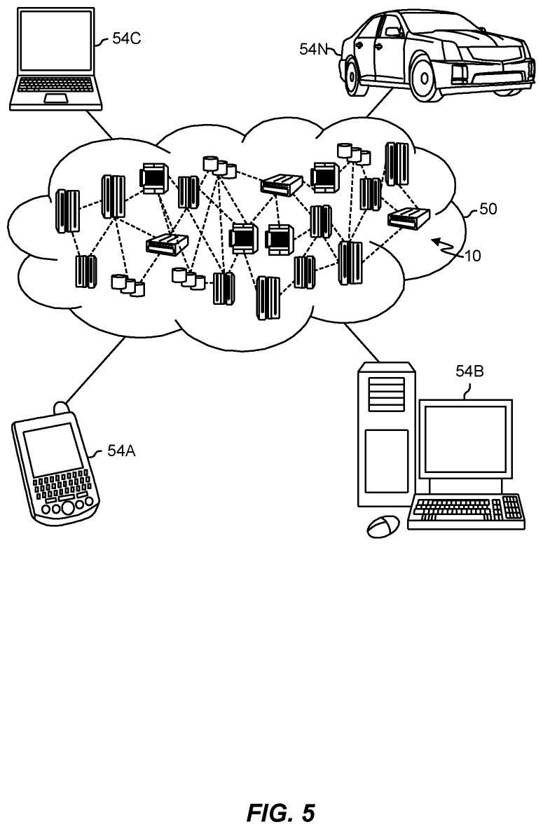

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

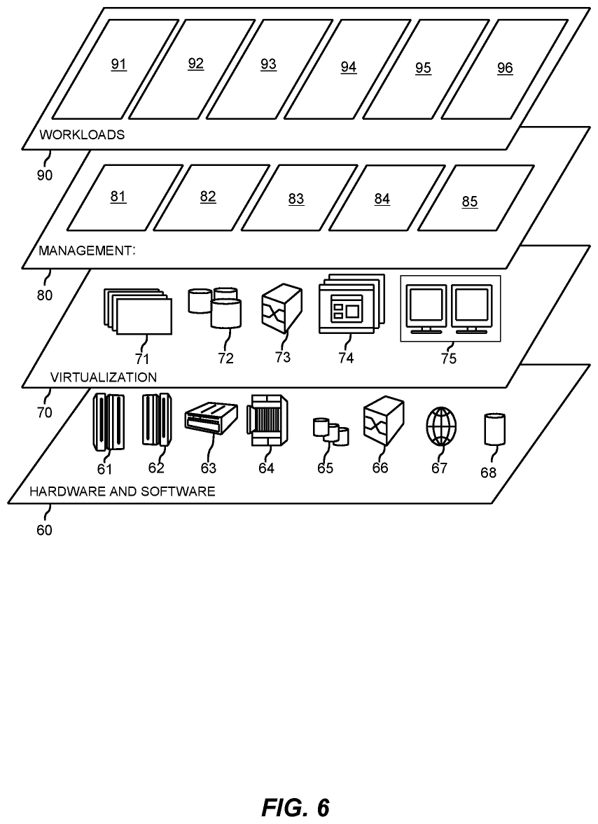

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and user query input processing and natural language processing application processing 96.

A computer program product of the present disclosure comprises one or more computer readable hardware storage devices having computer readable program code stored therein, said program code executable by one or more processors to implement the methods of the present disclosure.

A computer system of the present disclosure comprises one or more processors, one or more memories, and one or more computer readable hardware storage devices, said one or more hardware storage device containing program code executable by the one or more processors via the one or more memories to implement the methods of the present disclosure.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present disclosure.

What is claimed is:

1. A computer-implemented method for optimizing expansion of user query input in natural language processing applications, the computer-implemented method comprising:
identifying a lexical answer type for a user query input wherein the user query input is in the form of a natural language input;
feeding the lexical answer type into a query expansion method to expand the user query input with one or more precise terms based on the lexical answer type; and
outputting one or more lexical answer type query expansions for use as inputs into a natural language processing application.

2. The method of claim 1, wherein identifying a lexical answer type for a user query input is based on a domain appropriate lexical answer type extraction for a detected domain of the user query input.

3. The method of claim 1, further comprising:
ranking the one or more lexical answer type query expansions by evaluating and weighting the lexical answer type query expansions based on a context of the user query input.

4. The method as claimed in claim 3, wherein ranking the one or more lexical answer type query expansions by evaluating and weighting the lexical answer type query expansions based on a context of the query comprises:
using one or more semantic concepts, including the lexical answer type, from the user query input as inputs to one or more active knowledge graphs of a query expansion method, with concepts associated with the lexical answer type amplified as inputs; and
sorting query expansions in a final activated sub-graph by relevance to the user query input.

5. The method as claimed in claim 4, wherein sorting query expansions includes using one or more technique selected from the group consisting of: degree of separation from lexical answer type concepts; degree of separation from a most highly activated concept; and
overall activation weight.

6. The method of claim 1, further comprising:
selecting a number of the lexical answer type query expansions; and
using the number of the lexical answer type query expansions to generate an expanded structured query.

7. The method of claim 6, wherein selecting the number of the lexical answer type query expansions comprises:
automatically selecting a top number of expansions.

8. The method of claim 6, wherein selecting the number of the lexical answer type query expansions comprises:
receiving a user selection of a number of expansions; and
feeding back the user selection of expansions to enhance future expansions and context weightings.

9. The method of claim 1, wherein feeding the lexical answer type into the query expansion method comprises:
using a synonym lookup using a categorical nature of the lexical answer type.

10. The method of claim 1, further comprising:
using the lexical answer type for post-search filtering of results.

11. A system for optimizing expansion of user query input in natural language processing applications, the system comprising:
a memory; and
a processor in communicated with the memory, the processor being configured to perform operations comprising:
identifying, via a lexical answer type extraction component, a lexical answer type for a user query input wherein the user query input is in the form of a natural language input;
receiving as input, via a query expansion component, the lexical answer type to expand the query with one or more precise terms based on the lexical answer type; and
outputting one or more lexical answer type query expansions, via a query expansion output component, for use as inputs into a natural language processing application.

12. The system of claim 11, wherein the lexical answer type extraction component is a domain appropriate lexical answer type extraction component for a detected domain of the user query input.

13. The system of claim 11, the operations further comprising:
ranking, via a ranking component, the one or more lexical answer type query expansions by evaluating and weighting the lexical answer type query expansions based on a context of the query.

14. The system of claim 13, wherein the ranking operation comprises:
using one or more semantic concepts, including the lexical answer type, from the user query input as inputs to one or more active knowledge graphs of a query expansion method, with concepts associated with the lexical answer type amplified as inputs; and
sorting query expansions in a final activated sub-graph by relevance to the user query input.

15. The system of claim 11, the operations further comprising:
selecting, via a selecting component, a number of the lexical answer type query expansions; and
using the number of the lexical answer type query expansions to generate an expanded structured query.

16. The system of claim 15, the operations further comprising:
selecting, automatically, a top number of the expansions via the selecting component.

17. The system of claim 15, the operations further comprising:
receiving, via the selecting component, a user selection of a number of the expansions; and
feeding back the user selection of the number of the expansions, via a feedback component, to enhance future expansions and context weightings.

18. The system of claim 11, wherein receiving as input, via a query expansion component, the lexical answer type comprises:
using a synonym lookup using a categorical nature of the lexical answer type.

19. The system of claim 11, the operations further comprising:
using the lexical answer type for post-search filtering of results.

20. A computer program product for optimizing expansion of user query input in natural language processing applications, the computer program product comprising a computer readable storage medium having program instructions embodied therewith, the program instructions being executable by a processor to cause the processor to:
identify a lexical answer type for a user query input wherein the user query input is in the form of a natural language input;
feed the lexical answer type into a query expansion method to expand the user query input with one or more precise terms based on the lexical answer type; and
output one or more lexical answer type query expansions for use as inputs into a natural language processing application.
